(19) United States
(12) Patent Application Publication
(10) Pub. No.: US 2007/0022228 A1
(43) Pub. Date: Jan. 25, 2007

(54) Method to create expandable storage using serial ATA HDD

(76) Inventors: Allison Winifred Hicks, Richardson, TX (US); Raghuram Madabushi, Plano, TX (US); Thomas Ellis Ballew, Plano, TX (US)

Correspondence Address: TEXAS INSTRUMENTS INCORPORATED, P O BOX 655474, M/S 3999, DALLAS, TX, 75265, US

(21) Appl. No.: 11/187,473

(22) Filed: Jul. 22, 2005

(51) Int. Cl. G06F 3/00

(52) U.S. Cl. 710/51

(57) ABSTRACT

An external SATA hard disk drive is modified to contain a port multiplier having at least one additional external device physical layer which permits multiple external hard disk drives to be connected to a single external SATA port on a set top box, television receiver or personal computer.

### TECHNICAL FIELD OF THE INVENTION

The present invention relates to the expansion of hard disk drives or flash memories external to a device and more specifically to the expansion in the number of hard disk drives or flash memories connected to a single external SATA hard disk drive port.

### BACKGROUND OF THE INVENTION

Set top boxes are utilized by cable television companies and satellite television providers for tuning and decoding of television signals on a cable television or satellite television system so that these can be received by the user. Today, these devices are typically purchased by the cable television companies or satellite television providers and leased or sold to their subscribers. More advanced set top boxes may have an internal hard disk drive which allows the user to pause live television or record a show on a channel other than the channel being watched or at a time which is not convenient for the user to watch directly. Three changes, one in the way television is broadcast, a second in the way cable boxes are sold and a third regarding hard disk drives will effect future set top box designs.

High Definition television programs are currently being broadcast and will eventually take over the market so that all shows will be broadcast in high definition format. High Definition signals require substantially more information be broadcast, which, in turn, requires substantially more information be stored for a television show of a given length.

The second factor that will change the future for set top boxes is the OpenCable initiative which was developed at Cable Labs to permit the cable industry to deploy interactive devices over cable so that these devices can be sold at retail and provide interoperability. Thus, in the future, subscribers to a cable television service or satellite television service will be able to buy set top boxes at retail and a security card from their local provider and avoid the need to lease or buy equipment from the cable television or satellite television company. When the subscriber moves from one location to another, all that will be necessary is a new security card for the new service provider. Once these devices are sold at retail, there will be intense competition among the manufacturers to produce a device that is attractive to the general public. This is a large departure from the current condition in which the cable companies or satellite providers establish the parameters that will be present in the set top boxes.

The third change is already underway. Parallel ATA hard drives reached their performance limit at data rates of 133 MB/sec. This interface has been replaced by a serial ATA (SATA) interface which has higher data rates and utilizes low voltage signaling. The SATA interface replaces the 80 conductor ribbon cable utilized by the parallel interface with a four conductor cable and thus avoids problems associated with the ribbon cable and blocking air flow within the box and the folding of cable during assembly. Data is sent out in a serialized form as a differential signal pair having a 250 mV signal swing which is much less of the 3.3 or 5 volt signal swing utilized in parallel ATA interfaces. Initial SATA interfaces had a data rate of 150 MB/sec which required a speed of 1.5 Gbps for the serial data transmission. Currently second generation SATA devices are being sold which have a data rate of 300 MB/sec which necessitates a transmission speed of 3.0 Gbps. The third generation SATA devices will have a data transmission rate of 600 MB/sec, which requires a transmission speed of 6.0 Gbps. The SATA interface can be utilized for both internal or external hard disk drives by changing the physical layer PHY to provide the extra driving power needed for the longer external cables.

Given the highly competitive nature of the consumer electronics market, a likely product will be an entry level set top box having either a small internal hard disk drive or no internal hard disk drive. This device may be provided with an external SATA interface port so that a hard disk drive or an additional hard disk drive can be added to the device at a later time. The number of such devices that can be added will be determined by the manufacturer of the cable box by providing eternal ports for the connection of additional hard disk drives. One way this can be accomplished is shown in FIG. 1. In FIG. 1, there is a separate external SATA interface for each hard disk drive that may later be connected to the device. This requires additional circuitry for each port as well as switching logic to control which ports will be utilized for a particular data storage or retrieval. In FIG. 1 set top box 102 contains a host controller 104 which may contain an internal hard disk drive 106. The host controller is coupled to a SATA physical layer circuit 112 which has two (2) external physical layers PHY1 and PHY2, for example. The host controller 104 may be coupled to the physical layers 114, 116 via a SAPIS interface, for example. Each of the physical layers is coupled to an external hard disk drive 122, 124 via SATA links 118, 120.

The SATA interface standard provides for port multipliers which will allow multiple devices to be connected while sharing a portion of the circuitry. Thus, as shown in FIG. 2, a set top box equipped with at SATA port multiplier will share the status and control, control port physical layer and link layer SM but still require a device port physical layer, which may be as a generation 2M physical layer, for example. In FIG. 2 the set top box 202 contains the host controller 204, which may contain an internal hard disk drive 206. The host controller is coupled via interface 208 to a SATA port multiplier 210. Port multiplier 210 contains a single status and control, control port PHY and link layer SM, which will be shared with the three (3) external device physical layers 210, 212, 214. The external device physical layers 210, 212, 214 are coupled via SATA interfaces 216, 218, 220 to external SATA hard disk drives 222, 224, 266, respectively. Thus, although some circuitry can be shared, a separate physical layer is required for each port for which a hard disk drive can be later connected. Utilizing either of these approaches requires the manufacturer to add additional circuitry to the set top box and thus increase its cost, which may be difficult in the highly competitive consumer electronics market.

Accordingly, it would be advantageous if the circuitry for a set top box could be minimized.

### SUMMARY OF THE INVENTION

A general object to the present invention is to provide a technique for allowing the expansion of external SATA hard disk drives for a set top box or other device utilizing external storage.

This and other objects and features are provided in accordance with one aspect of the present invention by an external memory device for adding memory to an apparatus for generating data signals comprising an external SATA interface port for coupling the external memory device to the apparatus for generating data signals and a port multiplier for connecting at least a second memory device to the apparatus for generating data signals.

Another aspect of the present invention comprises a data storage system having a source of data signals and a single external SATA port for connection to an external memory device. An external memory device comprising an external SATA interface port is coupled to the external SATA interface port on the source of data signals. A port multiplier provides at least one additional external SATA interface port for connecting another external memory device to the source of data signals.

### BRIEF DESCRIPTION OF THE DRAWINGS

FIG. 1 illustrates the connection of multiple external hard disk drives to a set top box;

FIG. 2 illustrates the coupling of three external hard disk drives to a set top box using a port multiplier; and

FIG. 3 illustrates and external hard disk drive of the present invention which can be used in a data storage system of the present invention.

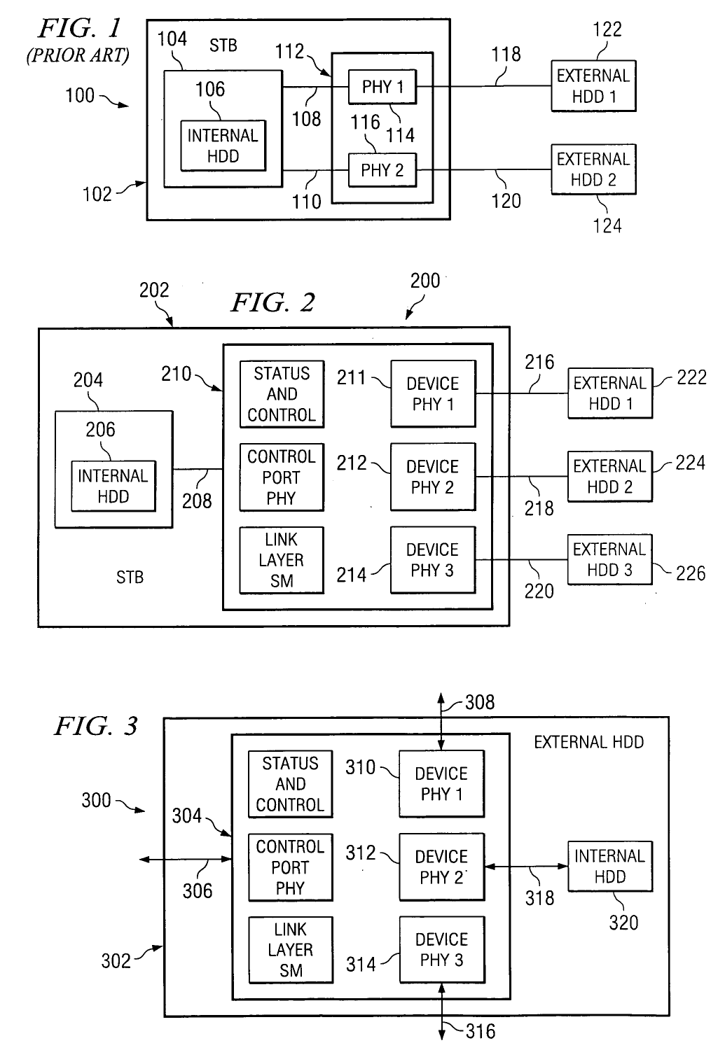

### DETAILED DESCRIPTION OF THE PRESENT INVENTION

The present invention enables the set top box, television receiver or a personal computer to have a single external SATA port and be used with multiple external SATA hard disk drives. The port multiplier illustrated in FIG. 2 is defined in the SATA specification only for use within the set top box. In the present invention, the port multiplier is placed within the external hard disk drive. This is illustrated in FIG. 3 generally as 300. In FIG. 3 the external hard disk drive 302 contains a port multiplier 304 which is different from the port multiplier illustrated in FIG. 2 because it contains two external device physical layers 310 and 314 and one internal device physical layer 312. The port multiplier 304 is coupled to an external SATA port on a set top box, television receiver or personal computer (not shown) via a four conductor SATA interface cable 306. The port multiplier contains the status and control, control port physical layer and link layer SM as defined for port multipliers in the SATA specification. The SATA specification prohibits the daisy-chaining of port multipliers. Therefore, the port multiplier 304 requires external SATA physical layers for each additional hard disk drive to be coupled to the system. The illustrated embodiment, two external physical layers 310, 314 are shown, but only a single external physical layer is required to practice the present invention. The internal-physical layer 312 is coupled via a SATA interface cable 318 to internal hard disk drive 320 so that the combination functions as an extra hard disk drive 302.

Utilizing this configuration, the manufacturer or the set top box, television receiver or personal computer need only provide a single external SATA port. If the user desires to expand external storage beyond a single hard disk drive, the user can purchase a hard disk drive containing the present invention which will expand the number of hard disk drives that are coupleable to the system based on the number of external physical layers provided by the port multiplier 304. Thus, for a user who chose a basic device having little or no internal storage, and who later added external storage and thereby discovered the advantages of having a hard disk drive connected to his set top box, for example, is not limited to the single external device nor must the user dispose of that external hard disk drive in order to increase the capacity of the external storage. This reduces the cost of a entry level set top box or personal computer and may allow the price to be reduced to the point where the set top box is integrated into the television receiver, for example.

While the invention has been shown and described with reference to preferred embodiments thereof, it is well understood by skilled in the art that various changes and modifications can be made in the invention without departing from the spirit and scope of the invention as defined by the appended claims. For example, flash media cards can be made which utilize the SATA standard for communication with a source of data signals. These flash media cards can be utilized with the present invention in place of a hard disk drive.

1. An external memory device for adding memory to an apparatus for generating data signals comprising
an external SATA interface port for coupling the external memory device to the apparatus for generating data signals;
a port multiplier for connecting at least a second memory device to the apparatus for generating data signals.

2. The memory device of claim 1 wherein the memory device comprises a hard disk drive.

3. The memory device of claim 1 wherein the memory device comprises a flash memory.

4. The memory device of claim 1 wherein the apparatus for generating data signals is a computer.

5. The memory device of claim 2 wherein the apparatus for generating data signals is a computer.

6. The memory device of claim 3 wherein the apparatus for generating data signals is a computer.

7. The memory device of claim 1 wherein the apparatus for generating data signals is a set top box.

8. The memory device of claim 2 wherein the apparatus for generating data signals is a set top box.

9. The memory device of claim 3 wherein the apparatus for generating data signals is a set top box.

10. A data storage system comprising:
a source of data signals having a single external SATA port for connection to an external memory device;
an external memory device comprising an external SATA interface port coupled to the external SATA interface port on the source of data signals, and a port multiplier providing at least one additional external SATA interface port for connecting another external memory device to the source of data signals.

11. The data storage system of claim 10 wherein the memory device comprises a hard disk drive.

12. The data storage system of claim 10 wherein the memory device comprises a flash memory.

13. The data storage system of claim 10 wherein the source of data signals is a computer.

14. The data storage system of claim 11 wherein the source of data signals is a computer.

15. The data storage system of claim 12 wherein the source of data signals is a computer.

16. The data storage system of claim 10 wherein the source of data signals is a set top box.

17. The data storage system of claim 11 wherein the source of data signals is a set top box.

18. The data storage system of claim 12 wherein the source of data signals is a set top box.

19. The data storage system of claim 13 further comprising a hard disk drive internal to the computer, the internal hard disk drive being connected to separate internal SATA interface port.

20. The data storage system of claim 16 further comprising a hard disk drive internal to the set top box, the internal hard disk drive being connected to separate internal SATA interface port.
